(19) United States
(12) Patent Application Publication
(10) Pub. No.: US 2019/0195205 A1
(43) Pub. Date: Jun. 27, 2019

(54) WIND TURBINE, BEARING HOUSING AND METHOD FOR OPERATING A WIND TURBINE

(71) Applicant: SIEMENS AKTIENGESELLSCHAFT, München (DE)

(72) Inventors: Uffe Erikson, Horsens (DK); Edom Lemma, Jerlev, Vejle (DK); Thorkil Munk-Hansen, Fredericia (DK); Kim Thomsen, Skørping (DK)

(21) Appl. No.: 16/322,176

(22) PCT Filed: Jun. 27, 2017
(86) PCT No.: PCT/EP2017/065753

§ 371 Date: Jan. 31, 2019

(30) Foreign Application Priority Data
Aug. 3, 2016 (EP) 16182605.2

(51) Int. Cl. F03D 80/70; F03D 80/50

(52) U.S. Cl. CPC F03D 80/70; F03D 1/00; F03D 80/50

(57) ABSTRACT

Provided is a wind turbine, including a rotor with a rotor shaft connected to a generator and a bearing housing, whereby the bearing housing includes at least a first bearing group and a second bearing group each comprising at least a primary bearing setup and a secondary bearing setup in which bearing is receivable, whereby the rotor shaft is rotatably arranged by the primary bearing setups or the secondary bearing setups.

### CROSS-REFERENCE TO RELATED APPLICATIONS

This application claims priority to PCT Application No. PCT/EP2017/065753, having a filing date of Jun. 27, 2017, based on EP Application No. 16182605.2, having a filing date of Aug. 3, 2016, the entire contents both of which are hereby incorporated by reference.

### FIELD OF TECHNOLOGY

The following relates to a wind turbine, comprising a rotor with a rotor shaft connected to a generator and a bearing housing.

### BACKGROUND

In conventional wind turbines, as known from prior art, the rotor shaft is rotatably arranged by at least two bearings received in the bearing housing. As the size of wind turbines keeps growing to above 10 MW it is a problem to keep down the maintenance and service costs during the lifetime. Especially the main bearing of such large wind turbines is a very expensive part to maintain and exchange, in particular on offshore wind turbines normally the whole bearing housing structure has to be exchanged.

In particular, in offshore constructions a service or maintenance fleet has to be mobilized to repair or maintain the wind turbine. Furthermore it is challenging to remove or exchange a main bearing as they are usually built in one piece, so that dismantling of the construction is required.

Besides that the wind turbine is out of operation until the maintenance fleet or service fleet is mobilized and the defective bearing is maintained or repaired, which leads to a high downtime of the wind turbine.

### SUMMARY

Therefore, an aspect relates to provide a wind turbine which is easier to repair or maintain, whereby the downtime is reduced.

This is inventively achieved by a wind turbine as initially described, whereby the bearing housing comprises at least a first bearing group and a second bearing group each comprising at least a primary bearing setup and a secondary bearing setup in which bearing means are receivable, whereby the rotor shaft is rotatably arranged by the primary bearing setups or the secondary bearing setups.

The embodiment is based on the consideration to have a primary bearing setup and a secondary bearing setup in each bearing group. Advantageously the rotor shaft is therefore either rotatably arranged by the primary bearing setup or the secondary bearing setup of each bearing group. If the primary bearing setup is used to pivot the rotor shaft and a failure or damage occurs to the primary bearing setup or one of the primary bearing setups, the wind turbine can be stopped and the secondary bearing setups can be used to pivot the rotor shaft. Therefore there is no need to wait until the maintenance or service fleet is mobilized and the primary bearing setup is exchanged or repaired, as the secondary bearing setup can be used to pivot the rotor shaft or arrange the rotor shaft rotatably, respectively, and the wind turbine is made operational at least for the time the maintenance or service fleet needs to maintain or repair the primary bearing setups. As a matter of fact, the downtime of the wind turbine in case of failure or damage can be reduced since there are secondary bearing setups provided that can take over the function of the primary bearing setups. Advantageously it is less extensive to use the secondary bearing setups than to have the whole bearing housing exchanged. To change the bearing setups, it is for example merely necessary to change the bearing means from the primary bearing setup, that is damaged or needs maintenance to the corresponding secondary bearing setup. Therefore, the time and effort to change the bearing means or bearing between the bearing setups is much less than to have the bearing setup or even the whole bearing housing exchanged.

It is also possible, if the primary bearing setups are irreparably damaged, for example in the case of a raceway damage in the rotor shaft, to use the secondary bearing setups as a “second life” for the bearing of the wind turbine, as the bearing means can be used in the secondary bearing setups and therefore the bearing of the wind turbine does not have to be exchanged which is, as described before, a time and cost intensive undertaking.

The first bearing group and the second bearing group are arranged in axially spaced locations. Therefore, the rotor shaft is rotatably arranged or pivoted at two different locations that are axially spaced. Of course, the rotor shaft is rotatably arranged by either the primary bearing setups or the secondary bearing setups of the first bearing group and the second bearing group. Besides that, it is also possible to have only the primary bearing setup of the first bearing group changed to the secondary bearing setup if only the primary bearing setup of the first bearing group is damaged or needs maintenance. Thus, the primary bearing setup of the second bearing group can be kept in operation as there is no damage or need for maintenance or repair of the primary bearing setup of the second bearing group.

According to a further embodiment of the invention, the primary bearing setup and the secondary bearing setup of the first bearing group and/or the primary bearing setup and the secondary bearing setup of the second bearing group are axially abutting each other. According to this embodiment the primary bearing setup and the secondary bearing setup that are assigned to the first or second bearing group are located axially in close contact to each other. Advantageously the rotor shaft is therefore rotatably arranged equally, independent of the pivoting or the rotatable arrangement, respectively, in the primary bearing setups or the secondary bearing setups, as they have axially similar locations.

According to another embodiment of the invention, the bearing setups comprise at least one circumferentially arranged notch in which at least one bearing means is receivable or received. According to this embodiment the at least one bearing means is receivable in each notch that is provided in the bearing housing and is part of the primary bearing setup and the secondary bearing setup. The notch is accessible without the need for dismantling and can therefore be accessed easier. Therefore in case of failure or damage the bearing means in the notch can be accessed and moved to the secondary bearing setups or more generally the other bearing setups so that the wind turbine can be made operational again before the failed or damaged bearing setup is maintained or repaired.

Advantageously, the at least one notch is fluid proof. According to this development of embodiments of the invention the notch or the notches in the first bearing setups or the secondary bearing setups can be made fluid proof so that a fluid bearing means can be received or a bearing fluid in general can be received in the notch or the notches.

The bearing means or bearing are fluid bearings and/or bearing elements, in particular sliding bearings, wherein each bearing element comprises at least one exchangeable bearing pad. By providing fluid bearings or bearing elements with exchangeable bearing pads it is possible, that a bearing setup in failure can be removed or it is further possible that the bearing elements that are assigned to the bearing setup can be removed with ease. The removed bearing elements, in case there is no damage to the bearing elements, can be used in the other bearing setup to keep the wind turbine operational.

The bearing housing comprises a service crane support to connect a service crane to the bearing housing.

The bearing housing comprises a support. The support is capable to connect a crane to the bearing housing.

Thus, a service crane can be located in the nacelle of a wind turbine in a central position. The crane is connected at a local point where it can reach almost any location in the surrounding.

The service crane support is connected to the bearing housing between the first bearing group and the second bearing group.

Thus, the crane is connected to the bearing housing, and thus to a rigid structure.

The bearing housing comprises a service crane that is connected to the service crane support.

The service crane support is connected to the bearing housing. A service crane is connected to the support. Thus, the bearing housing can carry the service crane. In addition, the service crane is exchangeable.

Advantageously, the service crane is rotatable around a mainly vertical axis that leads through the service crane support.

Thus, the service crane can be used to lift and place items in the nacelle, and to reach any location in the area surrounding the service crane and/or the bearing housing.

Advantageously, the service crane comprises an arm that is extendable and/or rotatable around a horizontal axis.

Thus, the area that the service crane can reach can even be enlarged.

Aside, the embodiment relates to a bearing housing for an inventive wind turbine as described above. Of course, all details, features and advantages that are described with respect to the wind turbine are transferable to the bearing housing. The embodiment further relates to a method for operating an inventive wind turbine, whereby the wind turbine is operated with the bearing means or bearing being mounted or received in the primary bearing setups or the secondary bearing setups, whereby the bearing setups in operation are changed, if at least one bearing setup related component is damaged or needs maintenance.

The inventive method is based on the consideration, that the inventive wind turbine provides an extra bearing setup or extra bearing setups, respectively. Those secondary bearing setups can be used, if there is a bearing related damage or need for maintenance in the primary bearing setup. In this case the affected bearing setup can be set out of operation, as the bearing means or bearing can be removed. In return the other bearing setup assigned to the same bearing group as the affected bearing setup can be set in operation, as a bearing means or bearing can be inserted.

By way of changing the bearing setup in operation the wind turbine can be made operational again with less effort than it takes to maintain or repair the affected bearing setup, which makes it possible to reduce the downtime of the wind turbine and the costs for repairing or maintaining the broken bearing setup.

The inventive method further comprises the following steps:

If at least one primary bearing setup is damaged or needs maintenance the secondary bearing setups are used to pivot or rotatably arrange the rotor shaft until the at least one primary bearing setup is repaired or maintained, and if the at least one primary bearing setup is irreparably broken the secondary bearing setups are kept in operation.

Thus it is possible to give the wind turbine a “second life” since the inventive wind turbine can be kept in operation as merely the affected bearing setup can be set out of operation and the other bearing setup, that is assigned to the same bearing group, can be made operational by inserting the proper bearing means or bearing. It is therefore not necessary to repair or maintain the affected bearing immediately as in conventional wind turbines. The other bearing setup can be used until the former bearing setup is repaired or maintained. Of course, it is also possible to still use the other bearing setup, although the former bearing setup is repaired or maintained, until a defect or failure affects the other bearing setup. It is also possible to re-change the bearing means or bearing from the other bearing setup to the former bearing setup as soon as the repair or maintenance procedure on the former bearing setup is finished.

In case of an irreparable damage to the former bearing setup it is, of course, also possible to keep the other bearing setup in operation until there is a defect or failure in the other bearing setup. In contrast to conventional wind turbines the inventive wind turbine is operational, until one of the bearing setups is irreparably broken and the other bearing setup needs maintenance or needs to be repaired. Therefore, especially in large wind turbines for offshore constructions the downtime can be reduced and the costs for mobilizing the maintenance fleet can also be reduced, as the maintenance fleet does not have to be mobilized for each failure or need for maintenance of a single bearing.

According to a further embodiment of the inventive method the bearing means or bearing of the primary bearing setups are used in the secondary bearing setups, if the primary bearing setups are not operational. Of course, it is also possible to use the bearing means or bearing of the secondary bearing setups in the primary bearing setups, if the secondary bearing setup is not operational.

Of course, each advantage, detail or feature, described with respect to the inventive method is transferable to the inventive wind turbine and the inventive bearing housing.

### BRIEF DESCRIPTION

Some of the embodiments will be described in detail, with reference to the following figures, wherein like designations denote like members, wherein:

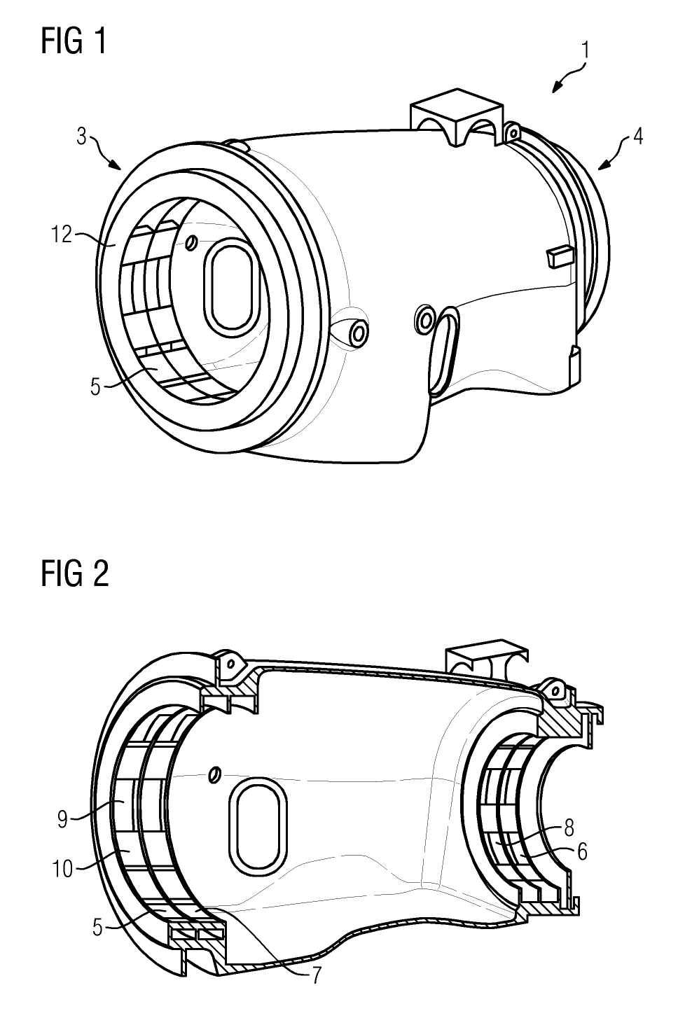

FIG. 1 shows a perspective view of an inventive bearing housing;

FIG. 2 shows a sectional drawing of the bearing housing from FIG. 1;

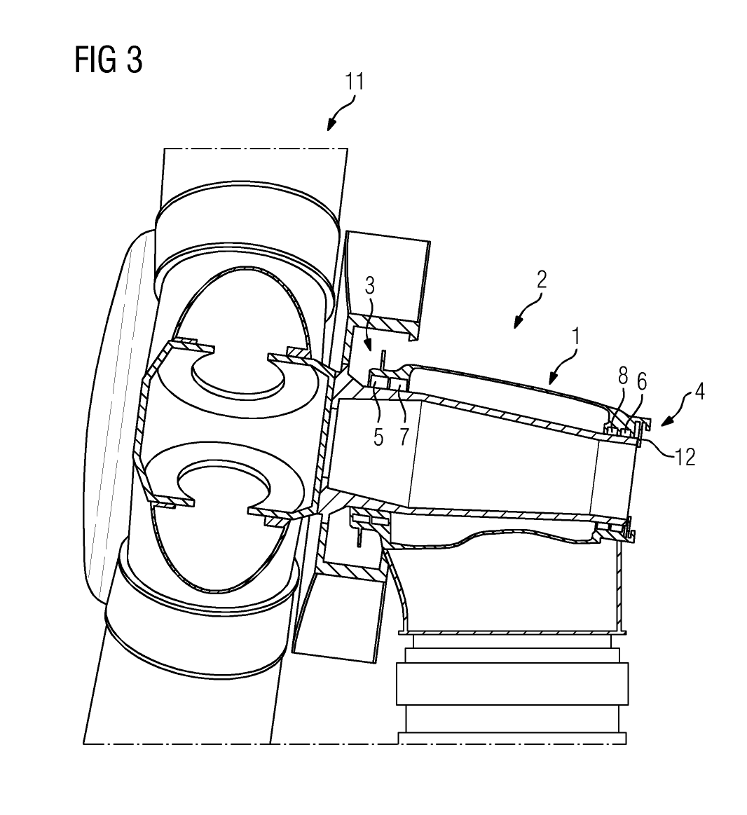

FIG. 3 shows a sectional drawing of an inventive wind turbine;

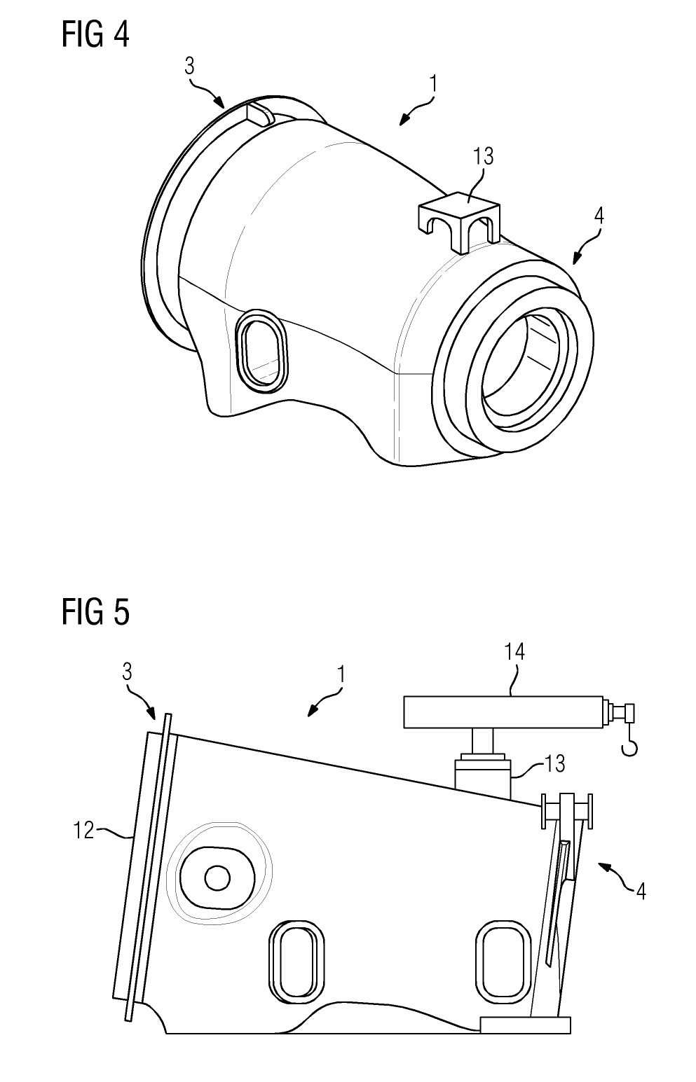

FIG. 4 shows a bearing housing comprising a service crane support;

FIG. 5 shows a bearing housing with a service crane attached to the support;

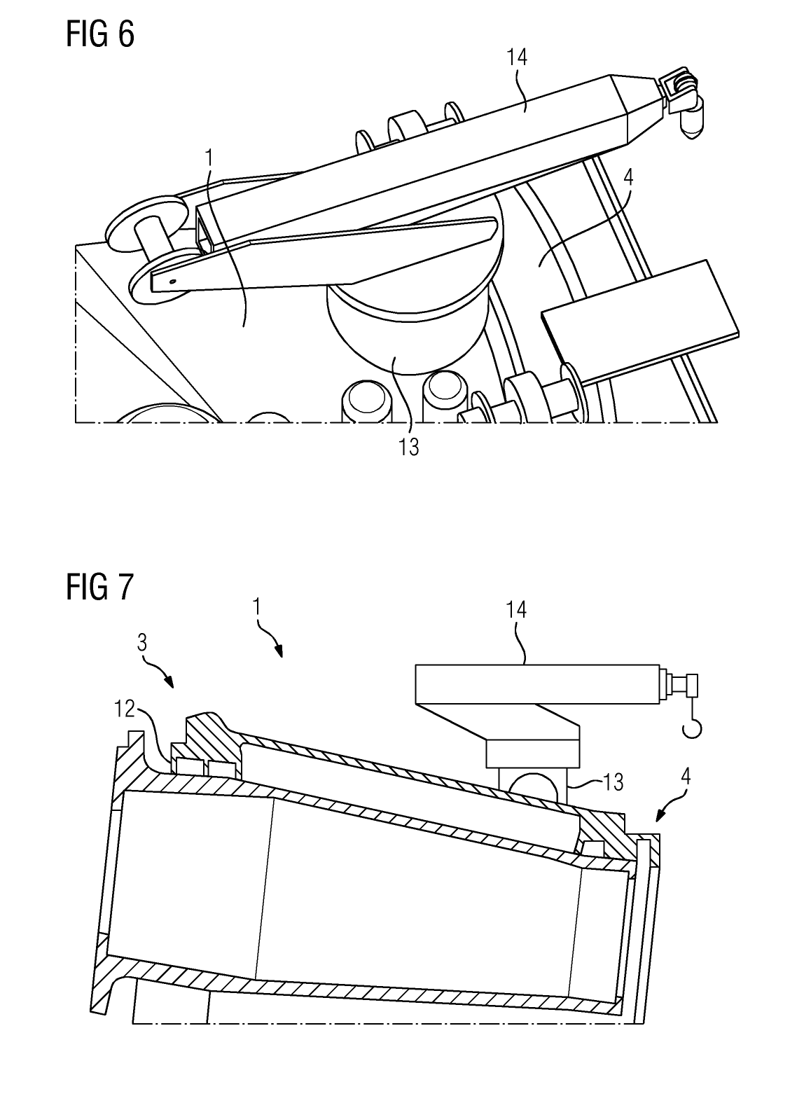

FIG. 6 shows a perspective view of the service crane on the bearing housing; and

FIG. 7 shows a crosscut of a bearing housing with a service crane.

### DETAILED DESCRIPTION

FIG. 1 shows a perspective view of a bearing housing 1 for a wind turbine 2, which is depicted in FIG. 3. The bearing housing 1 comprises a first bearing group 3 and a second bearing group 4, being axially spaced. The first bearing group 3 and the second bearing group 4 each comprise a primary bearing setup 5, 6 and secondary bearing setup 7, 8.

As can best be seen in FIG. 2, the primary bearing setup 5 and the secondary bearing setup 7 as well as the primary bearing setup 6 and the secondary bearing setup 8 abut each other axially. Therefore the pivot points for the rotor shaft (not shown) are similar independent of the use of the primary bearing setups 5, 7 or the secondary bearing setups 6, 8.

The bearing setups 5, 6, 7, 8 comprise notches 9 that are circumferentially arranged and able to receive bearing means or bearing, for example a fluid bearing. In case of sliding bearings exchangeable pads 10 can be received in the notches 9 and can be exchanged in case of pad damage. The notch 9 is, in particular, in case of a bearing fluid filled in the notch, built fluid proof.

Advantageously the bearing housing 1 has a primary bearing setup 5, 7 and a secondary bearing setup 6, 8 in the first bearing group 3 and the second bearing group 4, whereby either the primary bearing setups 5, 7 or the secondary bearing setups 6, 8 contain bearing means or bearing. Therefore, in case one of the bearing setups 5-8 is damaged or needs maintenance, the bearing setups 5-8 can be switched or changed, respectively. For example, if the primary bearing setup 5, 7 are in operation, so that the bearing means or bearing are received in the notches 9 of the primary bearing setups 5, 7 and a damage or a need for maintenance occurs at one of the primary bearing setups 5, 7 the respective affected bearing setup 5, 7 can be set out of operation and the corresponding secondary bearing setup 6, 8 can be set in operation. Thus, the wind turbine 2 can be kept operational, even if one of the primary bearing setups 5, 7 is not operational. Of course, it is also possible to change both primary bearing setups 5, 7 if only one of the primary bearing setups 5, 7 is affected.

After the affected primary bearing setup 5, 7 is repaired or maintained the primary bearing setups 5, 7 or the respective primary bearing setup 5, 7 can be used again, whereby the respective secondary bearing setup 6, 8 can be set out of operation and the bearing means or bearing can be switched from the respective secondary bearing setup 6, 8 into the primary bearing setup 5, 7. It is also possible to keep the secondary bearing setup 6, 8 in operation, even if the primary bearing setup 5, 7, that has previously been affected by the failure or damage is repaired or maintained.

In particular, if one of the primary bearing setups 5, 7 is irreparably damaged, for example if the raceway on the rotor shaft is irreparably damaged, the corresponding secondary bearing setup 6, 8 can be used instead. It is therefore not necessary to exchange the whole bearing housing 1, in contrast to conventional wind turbines, where a change of a bearing setup is not possible. Advantageously by way of embodiments of the invention the corresponding secondary bearing setup 6, 8 or one of the corresponding bearing setups can be used to give the wind turbine 2 a “second life”.

Of course, it is also possible to have more than a first bearing group 3 and a second bearing group 4. Each bearing group 3, 4 can also comprise more than the primary bearing setups 5, 7 and the secondary bearing setups 6, 8, so that even a third or more bearing setups can be provided.

FIG. 3 shows a wind turbine 2 with a bearing housing 1. The wind turbine 2 further comprises a rotor 11 connected to the bearing housing 1. The rotor shaft (not shown) of the rotor 11 is rotatably arranged by the first bearing group 3 and the second bearing group 4 or in the situation shown in FIG. 3 is rotatably arranged by the primary bearing setups 5, 7 respectively. As can further be seen from FIGS. 1 and 3, the bearing housing 1 comprises a generator mounting flange 12, by which a generator (not shown) can be connected with the bearing housing 1.

FIG. 4 shows a perspective view of a bearing housing 1 for a wind turbine. The bearing housing 1 comprises a first bearing group 3 and a second bearing group 4, being axially spaced. A service crane support 13 is connected to the bearing housing 1. The service crane support 13 is suitable to connect a service crane to the bearing housing 1.

FIG. 5 shows a bearing housing with a service crane attached to the support. The bearing housing 1 comprises a first bearing group 3 and a second bearing group 4, being axially spaced. A service crane support 13 is connected to the bearing housing 1. A service crane 14 is connected to the service crane support 13. The service crane 14 is shown in a park position, that is has during the operation of the wind turbine, when the service crane is not in use.

From this position the service crane 14 can be rotated to be used in the front part of the wind turbine nacelle, in the direction towards the bearing group 3. It can also be used for lifting operations in the back of the nacelle beyond the bearing group 4, or at the sides of the bearing housing. The service crane 14 can also reach upward, through a hatch in the roof of a nacelle canopy.

FIG. 6 shows a perspective view of the service crane on the bearing housing. The service crane 14 is connected to the bearing housing 1 by a service crane support 13. The crane comprises a hook on a rope, the hook is connected to an extendible arm and the rope can be reeled in and out be a winch.

FIG. 7 shows a crosscut of a bearing housing with a service crane. The bearing housing comprises a first bearing group 3 and a second bearing group 4. The two bearing groups 3, 4 are connected by the wall of the bearing housing 1. The service crane support is connected to the upper part of the bearing housing 1. The load of the crane 14 is distributed by the bearing housing 1 to the support structure of the wind turbine.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A wind turbine, comprising a rotor with a rotor shaft connected to a generator and a bearing housing, wherein the bearing housing comprises at least a first bearing group and a second bearing group each comprising at least a primary bearing setup and a secondary bearing setup in which bearing receivable, whereby the rotor shaft is rotatably arranged by the primary bearing setups or the secondary bearing setups.

2. The wind turbine according to claim 1, wherein the first bearing group and the second bearing group are arranged on axially spaced locations.

3. The wind turbine according to claim 1, wherein the primary bearing setup and the secondary bearing setup of the first bearing group and/or the primary bearing setup and the secondary bearing setup of the second bearing group are axially abutting each other.

4. The wind turbine according to claim 1, wherein the bearing setups comprise at least one circumferentially arranged notch in which the at least one bearing is receivable or received.

5. The wind turbine according to claim 3, wherein the notch is fluid proof.

6. The wind turbine according to claim 1, wherein the bearing is at least one of fluid bearings and sliding bearings, wherein each bearing element comprises at least one exchangeable bearing pad.

7. The wind turbine according to claim 1, wherein the bearing housing comprises a service crane support to connect a service crane to the bearing housing.

8. The wind turbine according to claim 7, wherein the service crane support is connected to the bearing housing between the first bearing group and the second bearing group.

9. The wind turbine according to claim 7, wherein the bearing housing comprises a service crane that is connected to the service crane support.

10. The wind turbine according to claim 9, wherein the service crane is rotatable around a mainly vertical axis that leads through the service crane support.

11. The wind turbine according to claim 9, wherein the service crane comprises an arm that is at least one extendable and rotatable around a horizontal axis.

12. A bearing housing for a wind turbine according to claim 1.

13. A method for operating a wind turbine according to claim 1, wherein the wind turbine is operated with the bearing being mounted or received in the primary bearing setups or the secondary bearing setups, whereby the bearing setups in operation are changed, if at least one bearing setup related component is damaged or needs maintenance.

14. The method according to claim 13, comprising the following steps:
If at least one primary bearing setup is damaged or needs maintenance the secondary bearing setups are used to pivot the rotor shaft until the at least one primary bearing setup is repaired or maintained,
If the at least one primary bearing setup is irreparably broken the secondary bearing setups are kept in operation.

15. The method according to claim 13, wherein the bearing of the primary bearing setups are used in the secondary bearing setups, if the primary bearing setups are not operational.
